(19) United States
(12) Patent Application Publication
(10) Pub. No.: US 2026/0347027 A1
(43) Pub. Date: Nov. 5, 2026

(54) DEVICE FOR SUPPLYING STOPPERS FOR SEALING CONTAINERS

(71) Applicant: Syntegon Technology GmbH, Stuttgart (DE)

(72) Inventors: Johannes Bäuerle, Obersontheim (DE); Sebastian Schwarz, Würzburg (DE); Melanie Harenberg, Schwäbisch Hall (DE); Selin Harenberg, Radebeul (DE); Pawel Ziaja, Feuchtwangen (DE)

(21) Appl. No.: 19/660,822

(22) Filed: Apr. 28, 2026

(30) Foreign Application Priority Data
Apr. 30, 2025 (DE) 10 2025 116 774.5

(51) Int. Cl. B65B 7/28; B65G 43/08

(52) U.S. Cl. CPC B65B 7/2807; B65B 7/2821; B65G 43/08

(57) ABSTRACT

A device for supplying stoppers for sealing containers. The device includes a guide component and/or a sorting stage with at least one conveying path, over which stoppers can be transported. A fault rectification device is provided with at least one sensor unit for detecting a malfunction in the at least one conveying path, with at least one pusher element, and with a control unit. The control unit is configured, in the event of a malfunction detected by the sensor unit during the transport of the stoppers in one of the conveying paths, to actuate the pusher element in such a way that the respective conveying path is traversed by the pusher element in order to push at least one stopper out of the conveying path and thus eliminate the malfunction.

### BACKGROUND

The invention relates to a device for supplying stoppers for sealing containers and, furthermore, to a method for eliminating malfunctions during the transport of stoppers – in particular in a described device. The device for supplying stoppers for sealing containers is equipped with a fault rectification device, by means of which faults or malfunctions during the transport of stoppers in the device can be rectified.

The containers are, in particular, pharmaceutical containers such as syringes, vials, cartridges or ampoules, in which liquid pharmaceutical products (liquid pharmaceuticals) are provided. Such containers are regularly sealed with stoppers. Such stoppers are usually silicone-coated and, where applicable, gamma-sterilized.

The device is used in particular in a system for filling liquids, specifically in a system for filling liquid pharmaceuticals in a cleanroom/isolator, to supply the stoppers to a sealing station for sealing the containers.

In principle, it is desirable to rectify faults and malfunctions in such systems without manual operator intervention wherever possible, so as not to compromise the conditions in the cleanroom/isolator through operator intervention. For this reason, the use of a robot within a cleanroom to carry out measures for rectifying malfunctions has already been considered.

It has become apparent that a non-specialized robot designed to rectify all malfunctions that may occur in such a system may require complex programming, and therefore specialized solutions may be more effective, particularly for malfunctions that occur more regularly in such a system.

### SUMMARY

Against this background, the object of the present invention is to at least partially solve the problems described with reference to the prior art. This object is solved by the invention in accordance with the features of the disclosure. Further advantageous embodiments are set out in the description and, in particular also, in the description of the figures. It should be noted that the person skilled in the art will combine the individual features in a technologically meaningful manner and thereby arrive at further embodiments of the invention.

The present description relates to a device for supplying stoppers for sealing containers, said device comprising a guide component and/or a sorting stage with at least one conveying path, over which stoppers can be transported, and further comprising a fault rectification device with at least one sensor unit for detecting a malfunction during the transport of the stoppers in the conveying paths, with at least one pusher element, and with a control unit, wherein the control unit is configured, in the event of a malfunction detected by the sensor unit in one of the conveying paths, to actuate the pusher element in such a way that the respective conveying path is traversed by the pusher element in order to push at least one stopper out of the conveying path and thus eliminate the malfunction.

The invention is based on the realization that malfunctions occur, in particular, during the supply of stoppers for sealing the containers in a device provided for this purpose. For this reason, a special device for supplying the stoppers is proposed here, which comprises a fault rectification device with which faults during the supply of the stoppers can be avoided.

Systems for filling containers often operate in a cyclical manner such that a group of containers (for example, 10 containers) is always filled together at a filling station and subsequently sealed together at a sealing station. For sealing, the stoppers are pressed into openings of the containers.

The stoppers are usually designed to be rotationally symmetrical. In embodiment variants, the stoppers are tapered conically. However, this is not essential. The device can also supply rotationally symmetrical cylindrical stoppers. The containers to be sealed are usually made of glass. Furthermore, the stoppers are preferably silicone-coated and/or gamma-sterilized. The stoppers may also be coated in other ways. Where applicable, the stoppers are also steam-sterilized. As a result, the stoppers are often slightly sticky, thus making their transport and separation challenging. In particular, the stoppers tend to adhere slightly to the conveying paths if they are silicone-coated or gamma-sterilized. A common malfunction in devices for supplying stoppers can therefore be a stoppage caused by a build-up of stoppers. Such a blockage or stoppage caused by a build-up of stoppers may occur in just one conveying path. It is also possible for such a stoppage caused by a build-up of stoppers to occur in several conveying paths simultaneously.

The stoppers are usually supplied in bulk material and must be separated and aligned in the device described here so that they can then be fed to a sealing station in defined positions. For separation, alignment and feeding to the stations, the stoppers are guided along conveying paths which pass through sorting stages and/or guide components. Reservoirs may be arranged between individual sorting stages and/or guide components, in which, for example, pre-aligned stoppers are temporarily stored before being fed to further sorting stages and/or a guide component. Alignment is carried out, for example, in such a way that a tapered end of all stoppers is oriented downwards so that it can be inserted into the openings of the containers to seal the containers. The defined positions are typically receiving positions on a component which conveys the stoppers on for sealing the containers. This component may, for example, be a fork having receiving positions for a number of stoppers. The number and arrangement of receiving positions on the component or fork preferably correspond to a number and arrangement of containers in a group that are to be sealed together.

The plurality of conveying paths described here, which can be traversed by the pusher element, are preferably formed in a guide component. The conveying paths may also be formed in a sorting stage. The conveying paths preferably run from a reservoir for the temporary storage of stoppers through a sorting stage and/or a guide component to a further reservoir and/or to receiving positions at which the aligned stoppers can be received for further processing. Within the device, a plurality of conveying paths are preferably arranged in parallel so that stoppers can be fed to receiving positions in parallel. Furthermore, a plurality of conveying paths are also preferably arranged in series, which are traversed by the stoppers in the device one after the other. First conveying paths are, for example, arranged in sorting stages and are intended, for example, for the sorting stage/pre-sorting stage of stoppers and they run, for example, from one hopper/reservoir to another reservoir. Second conveying paths are, for example, arranged in the guide component and they run, for example, from a reservoir to the receiving positions.

The device preferably comprises various elements that assist in the separation and alignment of the stoppers. These include, for example, a hopper in which the stoppers can be temporarily stored and into which the stoppers are replenished as bulk material via a feed pipe. These further preferably include various sorting stages, such as a pre-sorting stage and a further sorting stage. The device further preferably comprises overflow chutes and/or return chutes. Such overflow chutes and return chutes are, for example, collection containers into which, during a sorting stage, surplus, incorrectly aligned stoppers can overflow. Preferably, there are several sorting stages which together contribute to all stoppers being aligned. Due to the aforementioned challenges in the separation and alignment of stoppers, the device or the sorting stages are preferably designed such that not all stoppers need to be separated and aligned. The device or the sorting stages are designed such that stoppers which cannot be separated and aligned are returned. The device may comprise a return chute via which stoppers to be returned, and in particular stoppers that have overflowed, are then fed back to the sorting stages and/or the hopper.

Via the sorting stages, the stoppers in the device are preferably fed to a reservoir and, from this reservoir, then to a guide component, which then traverse the stoppers in order to reach the receiving positions. In embodiment variants, reservoirs may also be provided between individual sorting stages, in which stoppers can be temporarily stored.

The conveyance of the stoppers in the entire device, and in particular in the sorting stages and in the guide component, is preferably achieved by vibrations and/or oscillations of the components in contact with the stoppers. Vibrations and/or oscillations repeatedly lift and/or accelerate the stoppers, thereby moving them forward. This conveying principle is also commonly referred to as the ‘micro-throw principle’ and enables the stoppers to be transported very gently.

Both in the sorting stages and in the guide component, there are conveying paths in which malfunctions may occur during the transport of the stoppers; these can be rectified using the fault rectification device of the device described here.

The conveying paths or the guide component may often be designed merely in such a way that, once inserted into the conveying paths, stoppers must be transported forwards (in a conveying direction) to the receiving positions. An overflow or other return mechanisms, for example for misaligned stoppers, cannot always be provided, particularly in the area of the guide component immediately before the receiving positions. Consequently, a malfunction during the transport of the stoppers in the conveying paths regularly results in the supply of stoppers by the device having to be interrupted and the malfunction having to be eliminated. Such malfunctions can easily occur, particularly due to the silicone coating and/or the gamma sterilization and good adhesion of the stoppers in the conveying paths. Stoppers that become snagged or jammed in the conveying paths and/or at junctions between sorting stages and the guide component, etc., can also contribute to a stoppage caused by a build-up of stoppers. Such problems are exacerbated by sticky properties of the stoppers.

The present invention is based on the realization that malfunctions occur particularly frequently, especially in the described device for supplying stoppers and, within this device, particularly in the conveying paths or in a guide component and/or in sorting stages. The invention is further based on the realization that a fault rectification device specifically provided for the device is suitable for efficiently rectifying operational malfunctions.

The stoppers are transported through the conveying paths from the reservoir in a conveying direction. The fault rectification device now proposed here comprises a pusher element which can be used to empty conveying paths in a targeted manner, for example against the conveying direction, if a malfunction (e.g. a stoppage caused by a build-up of stoppers) occurs in a conveying path. To this end, the conveying path is traversed by the pusher element. When conveying/supplying stoppers using the device, stoppers are usually conveyed in a conveying direction from a hopper/reservoir to the receiving positions/containers. In embodiment variants, the fault rectification device is configured such that stoppers are pushed back against the conveying direction – for example, into a reservoir. In other embodiment variants, it is also possible for the pusher element to empty conveying paths in a targeted manner in the conveying direction into a container provided for this purpose. Such a container can, for example, be positioned in place of receiving positions during malfunction elimination to catch stoppers.

Compared to a robotic gripper, which is used to grasp and remove stoppers that are part of a malfunction, the pusher element described here is very simple in design. The pusher element need only be capable of exerting an undirected pushing force on the stoppers in the conveying path in order to remove them from the conveying path. The conveying path guides the stoppers back into the reservoir (or, in the conveying direction, into a reservoir). In particular, it is not necessary for the pusher element to grasp the stoppers (securely).

The device also comprises at least one sensor unit with which any malfunctions that occur can be detected. This sensor unit can be designed in a wide variety of ways. The sensor unit may, for example, be a camera positioned above the guide component, which can be used to detect malfunctions. In this case, a (complex) analysis of the data captured by the camera is regularly required in order to be able to infer faults/malfunctions (such as a stoppage caused by a build-up of stoppers) from the captured camera data. However, the sensor unit may also be designed differently and, for example, capture signals that enable the detection of faults during the transport of the stoppers more directly and with less complex analysis. Possibilities for this are suggested below.

The device further preferably comprises a control unit which is configured to actuate the pusher element, based on the data captured by the at least one sensor unit, in such a way that the conveying path is traversed to eliminate the malfunction.

It is particularly preferred if the pusher element is arranged at the end of a robot arm and if the control unit is configured to control the robot arm in order to move the pusher element.

It is also preferred if the robot arm comprises a boom at the end of which the pusher element is arranged, and it is further preferred if the device is designed such that, of the robot arm (during malfunction elimination), only the boom and the pusher element are arranged above the guide component and/or above the sorting stage.

The boom is preferably of a continuous design. This means that the boom preferably has no joints and/or hinges. Furthermore, the boom enables that no other element of the robot arm needs to be positioned above the guide component.

Such a design in particular prevents particles (such as abrasion and/or traces of lubricant) from elements of the robot arm from entering or falling onto the guide component, the conveying paths and/or the stoppers from above.

Preferably, the robot arm is designed such that the entire kinematic system for moving the pusher element is arranged to the side of the guide component or to the side of parts (conveying paths) of the device that guide stoppers, and only the continuous boom, at the end of which the pusher element is located, is arranged above the guide component.

Particularly preferably, the boom is designed to be narrow, so that airflow above the guide component is disturbed as little as possible by the boom and movements of the boom to eliminate the malfunction also cause as little additional airflows above the guide component as possible. Preferably, the cross-sectional shape of the boom is optimized to cause as few malfunctions to the airflows as possible. Preferably, the boom tapers towards the pusher element along its length and is designed to be particularly adapted to the forces occurring when pushing stoppers. This allows for a particularly small cross-section of the boom.

It is further preferred if at least one starting point is defined in the control unit along the course of each of the conveying paths, wherein the control unit is configured to traverse the respective conveying path starting from the respective starting point in the event of a malfunction detected in a conveying path.

When traversing a conveying path starting from a starting point, the pusher element preferably moves from the starting point to an end/beginning of the respective conveying path. Such an end may, for example, be a receiving position for stoppers and/or an (intermediate) reservoir between sorting stages and/or the guide component. Starting points are preferably stored as parameters in the control unit. Starting points may be provided at the beginning of conveying paths, at the end of conveying paths or along the course of conveying paths between the beginning and the end, and serve as entry points for the pusher element to eliminate malfunctions. When a malfunction is detected, a fixed program for operating the pusher element or the robot arm is preferably initiated in the control unit, in which the pusher element is inserted into the respective conveying path at the start position and then moved through the conveying path to the end/start of the conveying path in order to push everything located between the starting point and the end/start (all stoppers) out of the conveying path.

Preferably, the pusher element is designed such that its tip pushes the stoppers aside as it enters. Preferably, the control unit also has a routine stored for cases where it is not possible to insert the pusher element into the conveying path. The control unit is preferably thus configured or designed with a stored program routine that detects when the pusher element presses down on a stopper from above. This can be detected, for example, at an increased resistance and/or by an increased current draw. If necessary, the control unit or the program routine may be configured to then re-insert the pusher element into the conveying path at an alternative position near the start position (for example, at a distance of a few millimetres in front of or behind the start position). Such a routine is preferably configured to be repeated until the pusher element is successfully inserted into the conveying path.

Furthermore, it is preferable if at least two starting points are defined in the control unit along the course of each of the conveying paths, wherein the control unit is configured, in the event of a malfunction detected in a conveying path, to traverse this conveying path multiple times, wherein during a first traversal operation the conveying path is traversed starting from a first starting point, whereupon a further traversal operation then takes place starting from each of the remaining starting points, wherein the remaining starting points are approached one after the other in such a way that the respective distance traversed along the conveying path becomes longer each time.

This process is also preferably carried out in accordance with a program or program routine permanently stored in the control unit. The rationale behind this process is that (depending on how many stoppers are present in a conveying path) it is not possible to push all the stoppers out of the conveying path together in a traversal operation. Rather, the number of stoppers that must be pushed in a traversal operation should be limited. The conveying path is to be cleared path section by path section, with each section to be cleared lying between two starting points approached in succession. The various starting points divide the conveying path into path sections. With each individual traversal operation, only the stoppers located in a single path section need to be pushed out of the conveying path. This process ensures that all path sections of a conveying path are preferably cleared of stoppers or emptied one after the other. Depending on whether conveying paths are being cleared in a conveying direction or against a conveying direction, the order of the starting points to be approached is determined. If the conveying paths are to be emptied against the conveying direction (e.g. back into a reservoir), a starting point located closest to the start of the conveying path/to the reservoir is preferably approached first, followed by the starting points in the order of their distance from the start/the reservoir. If the conveying paths are emptied in the conveying direction (e.g. towards receiving positions for stoppers), starting points are preferably approached in reverse order.

In the event that one or more conveying paths have been emptied using the fault rectification device, start-up procedures may be provided which are carried out using the device to refill the conveying paths so that stoppers are once again present in front of the receiving positions. In such a start-up procedure, for example, a collection container for stoppers may be arranged below receiving positions at the end of a guide component. The conveyance of stoppers using the device can then be restarted. Once a sensor unit detects that stoppers are being supplied correctly again, the supply of stoppers for sealing containers can be restarted.

Furthermore, it is preferred if the control unit is configured to detect resistance which occurs when the at least one conveying path is traversed by the pusher element.

It is further preferred if the control unit is configured to monitor a forward movement of the pusher element when the at least one conveying path is traversed by the pusher element and to determine whether the forward movement corresponds to an expected movement.

Resistance when a conveying path is traversed by the pusher element and/or the absence of an expected movement of the pusher element can, for example, be detected by a sensor on the robot arm. In embodiment variants, such resistance can also be detected by sensors in a robot drive of the robot arm. For example, an evaluation of electrical drive currents of the robot drive may also be carried out.

Measurement values from the robot drive and/or a sensor on the robot arm are preferably transmitted to the control unit and may, where appropriate, be used to adjust the control of the robot arm or the pusher element when the at least one conveying path is transversed and when one of the traversal operations are performed.

Furthermore, it is preferable if the control unit is configured, when a forward movement and/or resistance when the at least one conveying path is transversed by the pusher element exceeds and/or falls below a threshold value, to abort a traversal operation and to start a further traversal operation at another starting point along the course of the respective conveying path.

In preferred embodiment variants, it is also possible for starting points for traversal operations to be selected arbitrarily along the conveying path, and for the conveying path to thus be divided, in the event of increased resistance, into as many individual path sections as necessary - each of which is cleared of stoppers - so that resistance when the at least one conveying path is traversed always remains below defined threshold values.

Particularly preferably, starting points for traversal operations along the conveying path can also be selected arbitrarily in order to adjust the length of the respective path sections cleared of stoppers. In preferred embodiment variants, any position along the conveying path can be approached as the starting point of a traversal operation.

It is also preferred if the control unit is further configured to restart the preceding traversal operation once the further traversal operation has been successfully completed.

For example, it is possible for a starting point for a first traversal operation to be set such that the entire conveying path is traversed by the pusher element. If, during the traversal operation, resistance to the pusher element is detected which exceeds a threshold value, the traversal operation may then be aborted. A further traversal operation can then be initiated at an additional starting point, whereby a path section between the point at which the first traversal operation was aborted and the reservoir is at least partially cleared. Subsequently, the pusher element can be moved back to the starting point of the first traversal operation and the preceding traversal operation can be restarted. Such a mode of operation of the device and the fault rectification device can be further refined by also, where appropriate, further subdividing the path section traversed during the further traversal operation and clearing it using additional sub-traversal operations, in order to prevent excessive resistance against the pusher element when clearing the conveying path.

It is further preferred if the at least one sensor unit comprises at least one path sensor with which transport of stoppers through a conveying path can be detected.

It is further preferred if the at least one sensor unit is specifically designed to detect when no (intended) transport of stoppers takes place through a conveying path.

As already described above, the at least one sensor unit may be a camera system capable of detecting malfunctions during the transport of the stoppers (e.g. stoppages caused by a build-up of stoppers). In further embodiment variants, it is possible for the sensor unit to comprise path sensors with which individual or multiple conveying paths can be monitored. Path sensors may, for example, be configured to monitor whether new stoppers appear regularly (at the intended distance) at a specific point on a conveying path or not. If, for example, a path sensor detects that no more stoppers are appearing at a specific point, a malfunction can be identified. Path sensors may, for example, be simple light barriers used to monitor specific positions along the conveying path in order to detect the transport of the stoppers.

Furthermore, the described device preferably comprises a clean air supply which is configured to generate, starting from a position above the guide component, a uniform, laminar clean air flow directed from top to bottom, with which the guide component is acted upon.

In particular, the clean air supply may also be part of a system for filling containers, in which the described device is arranged. Such a system may comprise a cleanroom/isolator in which the filling of the containers takes place and in which the device is also arranged.

With such a clean air flow, contaminants arising during the transport of the stoppers and/or during operation of the device are reliably transported away downwards. Contaminants may, for example, arise due to friction/abrasion on moving parts. Such a clean air flow therefore enables the highest purity requirements in the cleanroom to be met.

The fault rectification device, and in particular the robot arm used to rectify malfunctions above the guide component and/or above the sorting stages, impedes the clean air flow striking the guide component/the sorting stages from above. This impedance can be minimized by the design of the robot arm with the boom. Particularly preferably, the fault rectification device is arranged such that, when no fault rectification is taking place, the robot arm or the boom is not positioned above the guide component and/or the sorting stages. Preferably, there is a designated parking position for the robot arm/the boom to the side of the guide component and to the side of the sorting stages, in which the robot arm/the boom is always located when no fault rectification is being carried out. When the robot arm or the boom is in this parking position, the clean air flow through the robot arm/boom is preferably not impeded.

Also described here is a system for filling containers with a liquid, in particular with a pharmaceutical liquid, comprising a sealing station at which filled containers are sealed with stoppers, and further comprising a described device for supplying stoppers for the sealing station.

The specific advantages and design features described above in connection with the device are applicable to the system.

A method is also described here for eliminating malfunctions during the transport of stoppers in at least one conveying path in a device for supplying the stoppers, wherein the stoppers can be transported via the conveying path in a conveying direction, said method comprising the following steps:
a) detecting a malfunction during the transport of the stoppers in the conveying path;
b) inserting a pusher element into the at least one conveying path; and
c) traversing the at least one conveying path against the conveying direction by the pusher element in order to convey at least one stopper from the conveying path back into a reservoir in which the stoppers are supplied.

The specific advantages and design features described above in connection with the device are also applicable to the method. In particular, the programs and program routines described above, which may be stored in the control unit for operating the device and/or for operating the fault rectification device, may be part of the described method. The method may be carried out in particular with a described device and, most preferably, with a described device in a cleanroom.

### BRIEF DESCRIPTION OF THE DRAWINGS

The invention and the technical background of the invention are explained in more detail below with reference to the figures. The figures show preferred exemplary embodiments, to which the invention is not limited. It should be noted in particular that the figures, and in particular the proportions shown in the figures, are only schematic. In the figures:

FIG. 1: shows an example of a container with a stopper;

FIG. 2: shows a described device;

FIG. 3: shows a detail of a described device;

FIG. 4: shows a detail of a robot arm of a described device;

FIG. 5: shows a system comprising a described device.

### DETAILED DESCRIPTION

FIG. 1 shows, by way of example, a container 2 which is sealed with a stopper 5. Such a container 2 may, for example, be a syringe, an ampoule, a vial or a cartridge. Such a container 2 is usually made of glass. The stopper 5 is usually made of a plastic material. The stoppers 5 are usually rotationally symmetrical and conical in shape, so that their conical form allows them to be pressed into a round opening of the container 2 and they are held in place in the round opening of the container 2 by static friction. The stopper 5 is usually provided with a silicone coating, which ensures that the stopper 5 is held securely and forms a seal in the container. The silicone coating on the stoppers 5, or the stoppers 5 themselves, are also regularly gamma-sterilized. Other coatings may also be used on the stoppers 5. The stoppers 5 may also be steam-sterilized where appropriate.

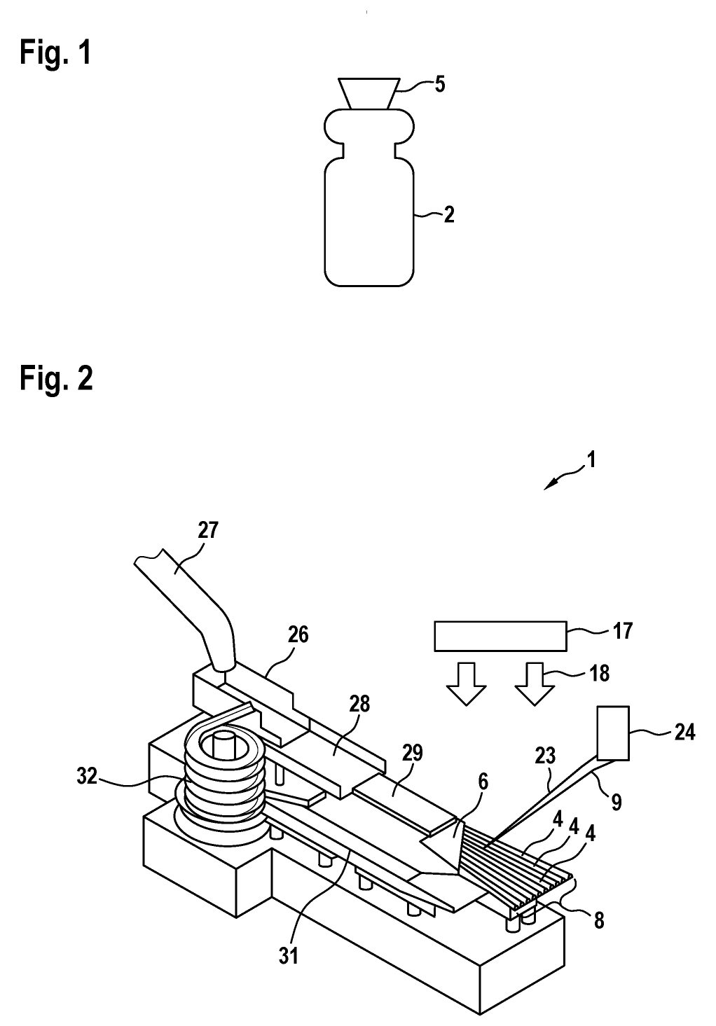

FIG. 2 shows a described device 1, which is designed to feed stoppers 5 for sealing containers 2 to receiving positions 8, from which the stoppers 5 can be used to seal containers 2. For example, a number of a plurality of receiving positions 8 are arranged side by side on a fork 30 (not shown here), with which the stoppers can then be placed onto containers 2 (also not shown here).

For reliable sealing of containers 2 with stoppers 5, it is crucial that all receiving positions 8 of a fork 30 are fully occupied by stoppers 5. The handling of stoppers 5 using the device 1 described here is occasionally impaired. This is due in particular to the silicone coating and the gamma sterilization of the stoppers 5. The stoppers 5 regularly adhere to components of the device 1, particularly as a result of this treatment. For example, stoppers 5 may become jammed in conveying paths 4 and/or at transitions between sorting stages 28, 29 and/or the guide component 3, which may be exacerbated or maintained by the treatment. This makes transport of the stoppers 5 more difficult. A monitoring system to check whether stoppers 5 are being transported by the device as intended is provided and described above. Also provided is a fault rectification device 9, with which faults during the transport of the stoppers 5 can be rectified if such faults have been detected by a monitoring system.

The configuration of a device 1 for supplying stoppers 5 shown in FIG. 2 is merely illustrative. The device 1 may also be configured differently. In particular, the device 1 comprises a guide component 3 with a plurality of conveying paths 4. Stoppers 5 are transported through each of the conveying paths 4 to the receiving positions 8. The distance of the receiving positions 8 is determined by the course of the conveying paths 4. Faults during the supply of stoppers 5 occur in particular during the transport of the stoppers 5 through these conveying paths 4. Such a fault may, for example, be a stoppage caused by a build-up of stoppers, in which several stoppers 5 have become wedged in a conveying path 4, so that no further transport of stoppers through the conveying path 4 takes place. For this reason, the fault rectification device 9 is designed to rectify such faults during the transport of the stoppers 5 in the conveying paths 4. The fault rectification device 9 comprises, in particular, a robot arm 23 which is driven by a robot drive 24 shown schematically here and which is explained in more detail below with reference to the subsequent figures.

Stoppers 5 are fed to the guide component 3, which contains the conveying paths 4, from a reservoir 6 in which the stoppers 5 are supplied in an aligned state. The reservoir 6 is filled with stoppers 5 from a hopper 27. The stoppers 5, in turn, enter the hopper 27 in a disordered and unaligned state as bulk material via a feed pipe 26. From the hopper 27, the stoppers 5 are fed to the reservoir 6 via several sorting stages (here, pre-sorting stage 28 and sorting stage 29). Conveying paths 4 are also provided in the sorting stages 28, 29, through which stoppers are transported. Preferably, a pre-orientation of the stoppers 5 takes place in the pre-sorting stage 28, and in the sorting stage 29, incorrectly oriented stoppers 5 are then sorted out. By ‘pre-orientation’ or ‘orientation’ is meant here, in particular, that the stoppers are aligned in such a way that the axes of all stoppers 5 in the reservoir 6 are aligned identically and (in the event that the stoppers 5 are conical in shape) the conical shape of all stoppers 5 in the reservoir 6 is also aligned identically. Even in the pre-sorting stage 28 and the sorting stage 29, it is not often always possible to ensure that all stoppers 5 are correspondingly correctly aligned. For this reason, a type of return chute 31 is usually provided, in which incorrectly aligned stoppers 5 can be sorted out from the various sorting stages 28, 29. From the return chute 31, the stoppers 5 are then returned, for example via a return conveyor 32 designed here as a spiral, back in front of the sorting stages 28, 29 in order to attempt to align the stoppers 5 once again.

The entire device 1, and in particular the components of the device 1 that transport stoppers 5, are preferably operated under cleanroom conditions. Typically, a clean air supply 17 is arranged above the device 1, from which, during operation of the device 1, a uniform, as laminar as possible clean air flow 18 flows downwards, so that the entire device 1 is continuously surrounded by clean air. The device 1 is preferably designed such that there are as few overlaps as possible which disrupt this clean air flow 18. The fault rectification device 9 is also designed such that there are as few impairments as possible to the clean air flow 18 above the guide component 3 and the conveying paths 4.

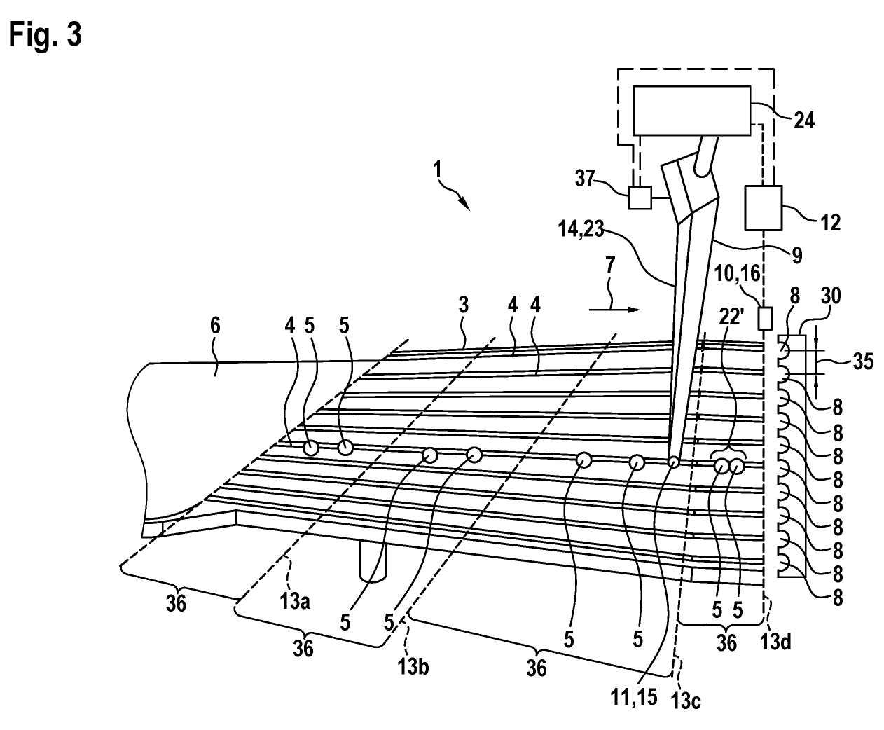

The guide component 3 with the conveying paths 4 of the device 1 is shown in FIG. 3 with further details. According to FIG. 3, the device and its mode of operation are explained by reference to the guide component 3 and by reference to the conveying paths 4 arranged therein, which run from a reservoir 6 to receiving positions 8. The following explanations are analogously applicable to sorting stages 28, 29 and conveying paths 4 arranged therein, which may, for example, run from a first reservoir and/or a hopper to a second reservoir.

FIG. 3 shows how the conveying paths 4 run from the reservoir 6 to the receiving positions 8. The stoppers 5 are transported through the conveying paths 4 in a conveying direction 7. FIG. 3 shows, by way of example, stoppers 5 being transported in one of the conveying paths 4 of the guide component 3. In practice (when the device 1 is in use), stoppers 5 are moved through all conveying paths 4. In particular, the conveying paths 4 are fanned out to set a desired distance 35 between the stoppers 5, which corresponds to the distance of receiving positions 8 for the stoppers 5.

The receiving positions 8 are arranged in particular on a fork 30, which is filled with stoppers 5 by the guide component 3 and the device 1. The fork 30, which is completely filled with stoppers 5 (with all receiving positions 8 occupied by stoppers 5), is then preferably used to place the stoppers 5 onto the containers 2 in a sealing station (not shown here) and to seal the containers 2 with the stoppers 5.

At least one sensor unit 10 is arranged at the sorting stage 28, 29 and/or on the guide component 3, which can be used to detect whether a fault occurs during the transport of the stoppers 5 through the conveying paths 4. Such a fault may, for example, be a stoppage caused by a build-up of stoppers 22 (shown here as an example), in which several stoppers 5 become wedged together in a conveying path 4, so that further transport of stoppers 5 through this conveying path 4 can no longer take place. The sensor unit 10 may, for example, comprise one or more path sensors 16, by means of which one or more of the conveying paths 4 can be monitored and by means of which it can be determined whether the (intended) transport of stoppers 5 through the conveying path 4 is taking place.

If a fault was detected by the sensor unit 10, the fault rectification device 9 is deployed to rectify the fault. To this end, the data from the sensor unit 10 are processed in a control unit 12 and converted into operating commands for a robot arm drive 24, by means of which the robot arm 23 is actuated to rectify the fault. The robot arm 23 has a boom 14, at the end 15 of which a pusher element 11 is arranged, which is used to rectify the fault during the transport of the stoppers 5. The boom 14 is preferably designed to be very narrow, so that the laminar clean air flow described above with reference to FIG. 2, which strikes the guide component 3 from above, is affected as little as possible by the robot arm 23 or the boom 14. The robot arm 23 is preferably designed such that, during fault rectification (in every phase of fault rectification), only the boom 14 of the robot arm 23, with the pusher element 11, and no other components are arranged above the guide component 3. The laminar clean air flow is only affected by the boom 14, which is deliberately designed to be very narrow and, where necessary, also flow-optimized to minimize its impact on the clean air flow.

During fault rectification, the robot arm 23 traverses, by the pusher element 11, the conveying path 4 in which a fault has been detected, against the conveying direction 7, in order to convey any stoppers 5 located in the conveying path 4 completely back into the reservoir 6 and thus empty the conveying path 4. Preferably, the robot arm 23 traverses the conveying path 4 by the pusher element 11 several times and in sections. Preferably, several traversal operations take place in succession, in which the pusher element 11 or the robot arm 23 traverses the conveying path 4, each starting at different starting points 13a, 13b, 13c, 13d. Preferably, a first traversal operation starts at a first starting point 13a, which is closest to the reservoir. This initially empties a path section 36 of the conveying path located between the reservoir 6 and the first starting point 13a back into the reservoir. Subsequently, a second traversal operation preferably starts at a second starting point 13b. During each traversal operation, the pusher element 11 preferably traverses the respective conveying path from the respective starting point 13a, 13b, 13c, 13d to the reservoir 6. During the aforementioned second traversal operation, a path section 36 between the second starting point 13b and the first starting point 13a is therefore emptied. The stoppers 5 present in this path section 36 are then also pushed through the other, already previously emptied path sections 36 on their way to the reservoir 6. This process is preferably then also repeated for all other designated starting points (here, for example, for the third starting point 13c and the fourth starting point 13d). In the event of a malfunction, particularly preferably all traversal operations are always carried out starting from all designated starting points 13a, 13b, 13c, 13d, regardless of whether stoppers 5 are present in the respective path section 36 or not. This can ensure that malfunctions or faults during the transport of the stoppers 5 are reliably rectified, even if the at least one sensor unit 10 has not carried out a completely precise assessment/analysis of the fault in question, but rather if, for example, a path sensor 16 of the sensor unit 10 merely detects that stoppers 5 are no longer arriving at the receiving position 8 in a conveying path 4.

In preferred embodiment variants, the device 1 and, in particular, the fault rectification device 9 are moreover also designed to monitor their own operation. For example, a sensor 37 designed as a force sensor or displacement sensor may be provided on the robot arm 23, with which it is possible, for example, to detect what force is required to traverse a conveying path 4 by the pusher element 11 and/or whether an advance of the pusher element 11 occurs as planned and intended during the traversal operation. Where appropriate, means may also be provided to monitor the robot drive 24 and, on the basis of operating parameters of the robot drive 24, to detect which forces and/or advance movements of the robot arm 23 or the pusher element 11 are occurring. Measurement parameters relating to the operation of the robot arm 23, obtained from sensors 37 or from the robot drive 24, are preferably transmitted to the control unit 12 and processed in the control unit 12 to determine operating parameters for the operation of the robot arm 23. Overall, this allows resistance to be detected during the traversal operation. Preferably, the device 1 or the fault rectification device 9 may then be configured such that the operation of the fault rectification device 9 is modified if it is detected that certain threshold values are reached and/or exceeded during the operation of the fault rectification device 9. If, for example, a sensor 37 detects resistance when traversing the conveying path 4, the traversal operation may be aborted. If necessary, a further traversal operation can then be started at a different starting point 13a, 13b, 13c, 13d. With reference to the starting points 13a, 13b, 13c and 13d shown by way of example in FIG. 3, it may, for example, be provided that initially only two traversal operations are regularly carried out to eliminate a detected malfunction, with a first traversal operation starting at the starting point 13b, whilst a second traversal operation starts at the starting point 13d. If it is not possible to clear the entire conveying path 4 of stoppers 5 with these two traversal operations, because, for example, stoppers 5 become further wedged as they are pushed back through the conveying path 4, then further traversal operations may be initiated from the starting point 13a and/or from the starting point 13c as necessary. If, for example, jammed stoppers 5 are present within the conveying path 4, such a further traversal operation may, if necessary, resolve jamming. If necessary, any number of starting points may be provided to divide path sections 36 of the conveying path 4 and thus ensure that the clearing of the conveying path 4 and the elimination of the malfunction are successful in any case. If necessary, the fault rectification device 9 may also be configured to allow free selection of suitable starting points for the traversal operation along the conveying path 4.

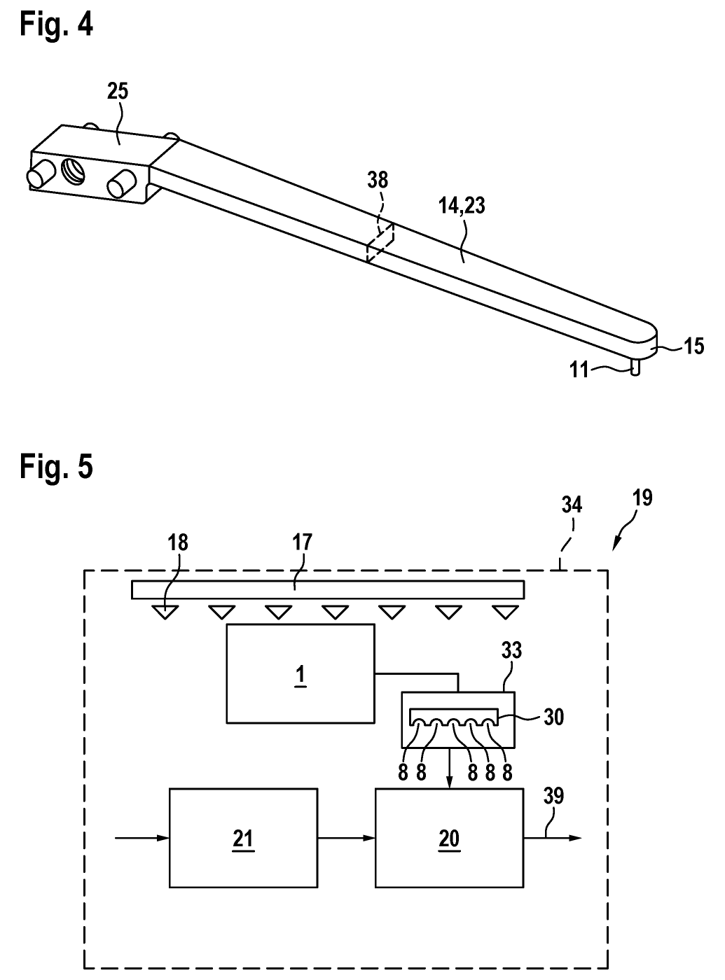

FIG. 4 shows a detail of a robot arm 23 of a described device. The boom 14 of the robot arm 23 is preferably narrow in design and tapers towards the end 15 with the pusher element 11. Opposite the end 15, the boom 14 has a connection geometry 25 by means of which the boom 14 is connected to further components of the robot arm 23, in particular to a robot drive 24. A cross-sectional shape 38 of the boom 14 is preferably designed such that a clean air flow striking the guide component 3 from above is affected as little as possible.

FIG. 5 shows a system 19 for filling containers 2 with a liquid – in particular for filling containers 2 with a liquid pharmaceutical. The containers 2 are preferably conveyed through the system 19 along a conveying track 39. Along the conveying track 39, there is first a filling station 21, at which the containers 2 are filled. The containers 2 then proceed to a sealing station 20. The sealing station 20 is supplied with stoppers for sealing the containers 2 by a stopper transfer system 33. The stopper transfer system 33 may also comprise the fork 30 shown in FIG. 3, with the receiving positions 8 for stoppers 5. The stopper transfer system or the receiving positions 8 of the fork 30 are filled or loaded with stoppers 5 by a described device 1.

The system 19 preferably comprises a cleanroom 34, in which the filling and the sealing of the containers 2 take place under cleanroom conditions. Preferably, the system 19

has a clean air supply 17, by means of which in particular the device 1 but also other components such as the filling station 21 and/or the sealing station 20 can be continuously supplied with a (laminar) clean air flow 18 from above.

### LIST OF REFERENCE SIGNS

1 device
2 containers
3 guide component
4 conveying path
5 stopper
6 reservoir
7 conveying direction
8 receiving position
9 fault rectification device
10 sensor unit
11 pusher element
12 control unit
13a first starting point
13b second starting point
13c third starting point
13d fourth starting point
14 boom
15 end
16 path sensor
17 clean air supply
18 clean air flow
19 system
20 sealing station
21 filling station
22 stoppage caused by a build-up of stoppers
23 robot arm
24 robot drive
25 connection geometry
26 feed pipe
27 hopper
28 pre-sorting stage
29 sorting stage
30 fork
31 overflow
32 return conveyor
33 stopper transfer system
34 cleanroom
35 distance
36 path section
37 sensor
38 cross-sectional shape
39 conveying track.

What is claimed is:

1. A device for supplying stoppers for sealing containers, said device comprising: a guide component and/or a sorting stage with at least one conveying path, over which stoppers can be transported, and further comprising a fault rectification device with at least one sensor unit for detecting a malfunction during the transport of the stoppers in the at least one conveying path, with at least one pusher element , and with a control unit, wherein the control unit is configured, in the event of a malfunction detected by the sensor unit in one of the conveying paths, to actuate the pusher element in such a way that the respective conveying path is traversed by the pusher element in order to push at least one stopper out of the conveying path and thus eliminate the malfunction.

2. The device according to claim 1, wherein the pusher element is arranged at an end of a robot arm and wherein the control unit is configured to control the robot arm in order to move the pusher element.

3. The device according to claim 2, wherein the robot arm comprises a boom at an end of which the pusher element is arranged, and wherein the device is configured such that, of the robot arm, only the boom and the pusher element are arranged above the guide component and/or above the sorting stage.

4. The device according to claim 1, wherein at least one starting point is defined in the control unit along the course of each of the conveying paths, wherein the control unit is configured to traverse the respective conveying path starting from the respective at least one starting point in the event of a malfunction detected in a conveying path.

5. The device according to claim 4, wherein at least two starting points are defined in the control unit along the course of each of the conveying paths, wherein the control unit is configured, in the event of a malfunction detected in a conveying path, to traverse this conveying path multiple times, wherein during a first traversal operation the conveying path is traversed starting from a first starting point, whereupon a further traversal operation then takes place starting from each of the remaining starting points, wherein the starting points are approached one after the other in such a way that the respective distance traversed along the conveying path becomes longer each time.

6. The device according to claim 1, wherein the control unit is configured to detect resistance which occurs when the at least one conveying path is traversed by the pusher element.

7. The device according to claim 1, wherein the control unit is configured to monitor a forward movement of the pusher element when the at least one conveying path is traversed by the pusher element and to determine whether the forward movement corresponds to an expected movement.

8. The device according to claim 1, wherein the control unit is configured, when a forward movement and/or resistance when the at least one conveying path is traversed by the pusher element exceeds and/or falls below a threshold value, to abort a traversal operation and to start a further traversal operation at another starting point along a course of the respective conveying path.

9. The device according to claim 8, wherein the control unit is further configured to restart the preceding traversal operation once the further traversal operation has been successfully completed.

10. The device according to claim 1, wherein the at least one sensor unit comprises at least one path sensor with which the transport of stoppers through a conveying path can be detected.

11. The device according to claim 10, wherein the at least one sensor unit is configured to detect when no transport of stoppers takes place through a conveying path.

12. The device according to claim 11, further comprising a clean air supply which is configured to generate, starting from a position above the guide component, a clean air flow directed from top to bottom, with which the guide component is acted upon.

13. A system for filling containers with a liquid comprising: a sealing station at which filled containers are sealed with stoppers, and further comprising a device according to claim 1 for supplying stoppers for the sealing station.

14. A method for eliminating malfunctions during the transport of stoppers in at least one conveying path in a device for supplying the stoppers, wherein the stoppers can be transported via the at least one conveying path in a conveying direction, said method comprising the following steps:
a) detecting a malfunction during the transport of the stoppers in the at least one conveying path;
b) inserting a pusher element into the at least one conveying path; and
c) traversing the at least one conveying path against the conveying direction by the pusher element in order to convey at least one stopper from the conveying path back into a reservoir in which the stoppers are supplied.

15. The device according to claim 12, wherein the clean air flow is uniform and laminar.

16. The system according to claim 13, wherein the liquid is a pharmaceutical liquid.
